(19) United States
(12) Patent Application Publication
(10) Pub. No.: US 2008/0169038 A1
(43) Pub. Date: Jul. 17, 2008

(54) THERMAL SHIELD AND METHODS OF CONSTRUCTION AND INSTALLATION

(76) Inventors: Timothy David Sellis, West Groove, PA (US); John Emerson Burdy, Morgantown, PA (US); Zhong Huai Zhang, Pottstown, PA (US); Linwood Ludy, Pottstown, PA (US); William T. Rubel, Downingtown, PA (US)

Correspondence Address: DICKINSON WRIGHT PLLC, 38525 WOODWARD AVENUE, SUITE 2000, BLOOMFIELD HILLS, MI, 48304-2970, US

(21) Appl. No.: 11/972,363

(22) Filed: Jan. 10, 2008

Related U.S. Application Data
(60) Provisional application No. 60/884,551, filed on Jan. 11, 2007.

(51) Int. Cl. B21D 53/88; B21D 51/16; B60K 13/04

(52) U.S. Cl. 138/149; 29/890.08; 29/455.1; 138/159; 138/161

(57) ABSTRACT

A wrappable heat shield for an exhaust pipe and methods of construction and installation thereor includes an outer layer of metal having opposite inner and outer faces extending between opposite sides. An inner layer of non-woven insulation is attached to the the outer layer by a crimped portion extending along one of the opposite sides of the outer layer. The inner layer has a width sufficient to extend completely about a circumference of the exhaust pipe and is arranged in continuous contact with the exhaust pipe about its circumference while the outer layer remains spaced therefrom.

### CROSS-REFERENCE TO RELATED APPLICATIONS

This application claims the benefit of U.S. Provisional Application Ser. No. 60/884,551, filed Jan. 11, 2007, which is incorporated herein by reference in its entirety.

### BACKGROUND OF THE INVENTION

1. Technical Field

This invention relates generally to thermal shields, and more particularly to wrappable multilayered thermal shields.

2. Related Art

Vehicles and other equipment that operate via an internal combustion engine contain various components that generate relatively high temperatures. If left unchecked, the heat from the components can have adverse affects on surrounding components. For example, an automotive vehicle has an exhaust system including exhaust pipes and catalytic converters which can reach 1200° Fahrenheit (° F.) or more. As such, it is generally desirable to place a thermal barrier, often referred to simply as a heat shield, adjacent the exhaust pipes and/or catalytic converter to prevent radiant heat from impinging adjacent components and from entering a passenger compartment of the vehicle. In addition, heat shields are often used within an engine compartment of the vehicle to prevent radiant heat from having adverse affects on surrounding components, electrical lines, and hoses, for example, wherein elevated temperatures are becoming more commonplace due modern engine packages creating cramped environments.

Although heat shields are well known and necessary, they typically comprise one layer of heavy, rigid material, which are becoming less effective in blocking the increased temperatures and can be difficult to form, generally requiring expensive machinery, or two or more layers of material attached to one another through the use of adhesives and/or fasteners which tend to be relatively thick and/or expensive. Accordingly, the heat shields are typically either relatively thick and expensive, thereby occupying valuable space within the vehicle, or thinner, rigid and relatively expensive.

### SUMMARY OF THE INVENTION

A heat shield that is hand wrappable about a circumference of an exhaust pipe is provided. The heat shield has an outer layer of wrappable metal material having opposite inner and outer faces extending between opposite side edges. The opposite side edges provide a width of the outer layer. The heat shield also has an inner layer of non-woven insulation material having opposite inner and outer faces extending between opposite side edges. The opposite side edges of the inner layer provide a width of the inner layer that is less than the width of the outer layer. The inner layer outer face faces the outer layer inner face and the outer layer side edges are arranged adjacent the inner layer side edges. At least one of the outer layer side edges is crimped over the adjacent inner layer side edge so that it compresses the inner layer to provide a crimped portion with the outer layer inner face remaining substantially unattached to the inner layer outer face. The inner layer width is sufficient to extend completely about the circumference of the exhaust pipe upon wrapping the heat shield about the circumference of the exhaust pipe.

Another aspect of the invention includes a method of constructing a wrappable heat shield for an exhaust pipe. The method includes providing an outer layer of metal material having opposite inner and outer faces extending between opposite side edges which form a width of the outer layer and providing an inner layer of non-woven insulation material having opposite inner and outer faces extending between opposite side edges which form a width of the inner layer. Then, placing the outer face of the inner layer in abutment with the inner face of the outer layer with the opposite side edges of the outer layer being arranged adjacent the opposite side edges of the inner layer. Further, crimping at least one of the side edges of the outer layer over the adjacent side edge of the inner layer to fix the outer layer to the inner layer with the inner face of the outer layer remaining unattached with the outer face of the inner layer.

Yet another aspect of the invention includes a method of installing a heat shield on an exhaust pipe. The method includes providing the heat shield with an outer layer of metal having opposite inner and outer faces extending between opposite side edges and an inner layer of insulation material having opposite inner and outer faces extending between opposite side edges arranged adjacent respective ones of the outer layer side edges. At least one of the outer layer side edges is crimped over the adjacent inner layer side edge to fix the outer layer to the inner layer with the inner face of the outer layer remaining substantially unattached to the outer face of the inner layer. Further, wrapping the heat shield about the exhaust pipe and bringing the inner layer into complete circumferential contact with the exhaust pipe.

Accordingly, given the content of a heat shield constructed in accordance with the invention, the heat shield is lightweight, durable, effective in preventing heat from radiating outwardly therefrom, easy to install, and among other things, is economical in manufacture and in installation and exhibits a long and useful life.

### BRIEF DESCRIPTION OF THE DRAWINGS

These and other features and advantages of the present invention will become more readily appreciated when considered in connection with the following detailed description of presently preferred embodiments and best mode, appended claims and accompanying drawings, in which:

FIG. 1 is a an assembled side view of a formable heat shield constructed according to one presently preferred embodiment mounted to an exhaust pipe of a vehicle;

FIG. 2 is a perspective view of the heat shield assembly in a disassembled state;

FIG. 3 is a schematic end view of the heat shield shown attached to the exhaust pipe;

FIG. 4 schematic end view of a heat shield constructed according to another presently preferred embodiment shown in an unformed state;

FIG. 4A is a schematic side view of the heat shield of FIG. 4 in a wrapped state;

FIG. 5 is an end view of the heat shield of FIG. 4A shown wrapped about a vehicle exhaust pipe;

FIG. 5A is a perspective view of a heat shield constructed according to another presently preferred embodiment;

FIG. 6 is a schematic side view of a heat shield constructed according to yet another presently preferred embodiment shown in an unformed state; and

FIG. 7 is an end view of the heat shield of FIG. 6 shown in a wrapped state about a vehicle exhaust pipe.

### DETAILED DESCRIPTION OF PRESENTLY PREFERRED EMBODIMENTS

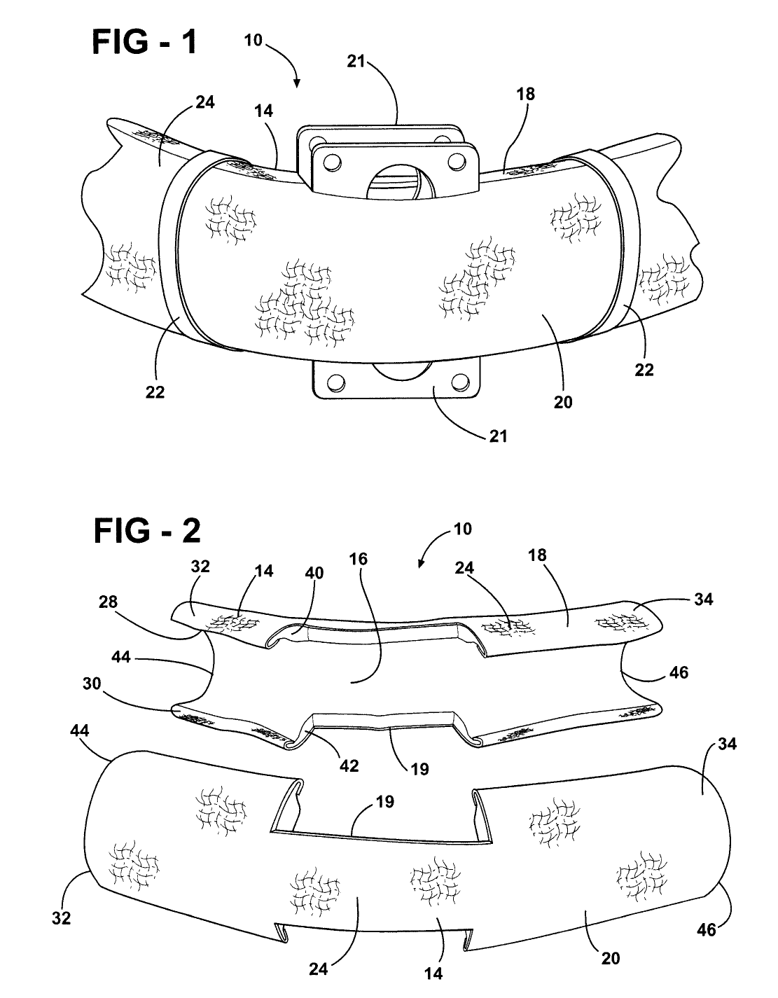

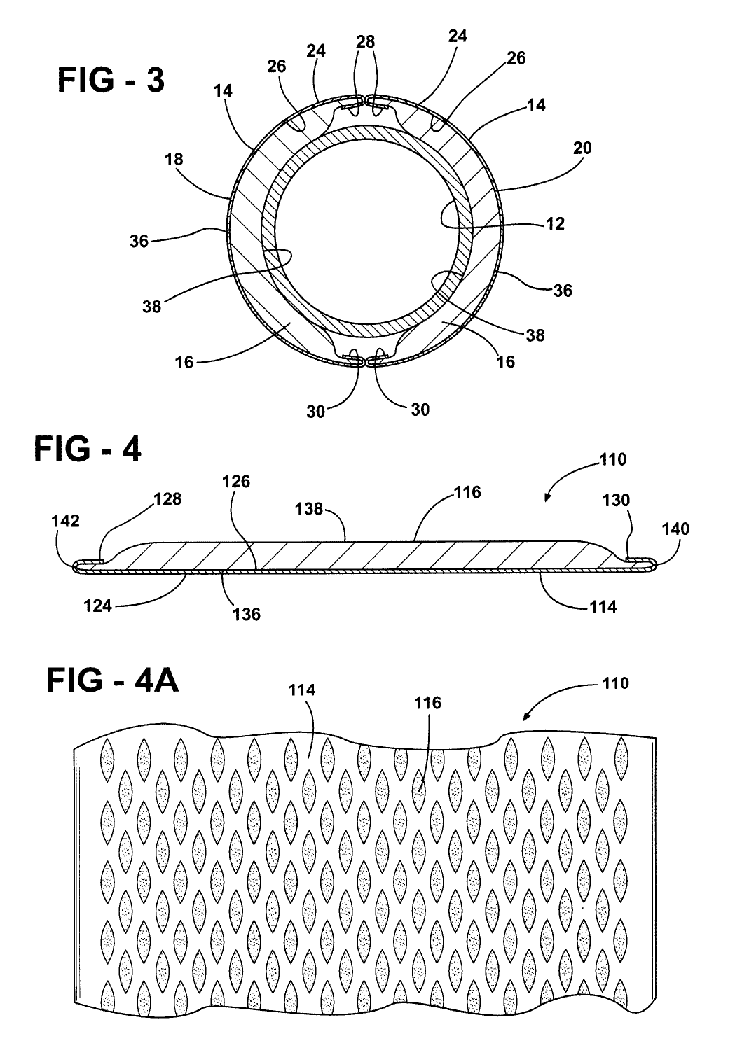

Referring in more detail to the drawings, FIGS. 1-3 show a thermal shield, referred to here after as heat shield 10, constructed according to one presently preferred embodiment of the invention. The heat shield 10 is shown formed about an exhaust pipe 12 (FIG. 3) of a vehicle, such as an automotive vehicle, motorcycle, snowmobile, or other vehicle having an exhaust system (not shown), to prevent heat from the exhaust pipe from having adverse affects on surrounding vehicle components. The heat shield 10 has a formable metallic outer layer 14 providing structure and protection to the heat shield 10, such as from debris, stones and the like, that can be kicked up from a road or ground surface. The outer layer 14 surrounds and is attached to an inner insulation layer 16 (FIGS. 2 and 3) that provides thermal insulation protection to prevent heat from radiating outwardly from the exhaust pipe 12. The heat shield 10 is light weight and economical in construction, and it can be readily formed about any size and shape of exhaust pipe. Accordingly, the heat shield 10 does not add greatly to the weight of the vehicle, and it can be used in a wide variety applications.

As shown in FIGS. 2 and 3, the heat shield 10 can be constructed having a pair of generally diametrically opposite portions or halves 18, 20 that can be generally symmetrical to one another, though they could be shaped differently from one another, depending on the application. The halves are shown formed having a generally C-shape in lateral cross section, such that they conform to the cylindrical exhaust pipe 12, and can have cut-out regions 19 to accommodate a mounting flange 21 on the exhaust pipe 12, if desired. The halves 18, 20 are attached to encapsulate the exhaust pipe 12 by placing the opposite inner layer portions, referred to hereafter as inner layers 16, in abutment with the exhaust pipe, and then fastening the halves to one another, such as with hose-type clamps or metal straps 22 constructed from high temperature material, such as stainless steel, for example. When attached to one another, the outer layer portions, referred to hereafter as outer layers 14, of each half is preferably maintained spaced from the exhaust pipe 12 so that it does not conduct heat therefrom, while the inner layers 16 of each half remain in abutment therewith to absorb the heat.

The outer layer 14 is formed from a relatively thin, light weight metal, such as aluminum or stainless steel, that can preferably be hand formed without the need of expensive forming machinery. As such, to be formable by hand, the thickness of the outer layer 14 is preferably between about 0.001-0.050 inches, and was formed from aluminum having a thickness of about 0.020 inches in the embodiment shown. The outer layer 14 of each half 18, 20 has opposite outer and inner faces 24, 26 extending between opposite side edges 28, 30 defining a width and opposite ends 32, 34 defining a length. The outer layer 14 can have a textured non-planar or undulating surface, such as by being corrugated having circumferentially extending peaks and valleys to enhance is flexibility without kinking, it can be constructed from expanded metal (e.g. expanded aluminum or expanded steel), or embossed, as shown. The embossed pattern can take on a variety of patterns, and is shown here, by way of example and without limitation as having a generally uniform pattern of peaks and valleys, such as that of an egg container, for example.

The inner layer 16 of each half 18, 20 is fabricated from a non-woven insulation material capable of absorbing heat in the ranges of 1200° F. or more, such as from silica, basalt, glass fiber material or other ceramic fibrous materials, and can also be constructed from polymer materials, such as polyester, for example. The inner layer 16 is provided having a thickness extending between opposite outer and inner faces 36, 38, respectively, suitable for absorbing the heat generated in application, and preferably is about 1/16 to 1 inch. The outer and inner faces 36, 38 extend between inner opposite side edges 40, 42 defining a width sufficient to fully encapsulate the circumference of the exhaust pipe 12, such that the metal outer layer 14 preferably does not come in contact with the exhaust pipe, and opposite ends 44, 46 defining a length of the inner layer 16. The width of the inner layer 16 is preferably less than the width of the outer layer 14.

In one embodiment, the inner layer 16 is generally centered on the outer layer 14, and the side edges 28, 30 of each of the outer layers 14 are folded or crimped over the side edges 40, 42 of each of the corresponding inner layers 16 to attach, lock or fix (attach, lock and fix are intended to mean substantially the thing and are thus used herein interchangeably with one another) the outer and inner layers 14, 16 to one another. Other than the crimped portion, the outer surface or face 36 of the inner layer 16 remains unattached with the inner surface or face 26 of the outer layer 14. Accordingly, it is not necessary to incorporate an adhesive layer between the outer and inner layers 14, 16 to facilitate attachment of the outer and inner layers 14, 16 to one another, although an adhesive layer could be used if desired. Upon crimping the outer layer 14 to the inner layer 16, the side edges 28, 30 are spaced outwardly from the inner face 38 of the inner layer 16 (FIG. 3), due to the inner layer 16 being compressed in the crimped portion, thus, facilitating maintaining the outer layer 14 in spaced relation from the exhaust pipe, as shown in FIG. 3.

A heat shield 110 constructed according to another presently preferred embodiment is shown in FIGS. 4 and 4A. The heat shield 110 has an outer layer 114 and an inner layer 116 constructed from the same corresponding materials as discussed above, represented here as from the aforementioned expanded metal material. The heat shield is a one piece construction capable of being wrapped by hand to encapsulate the exhaust pipe 12 is provided. The outer layer 114 has opposite outer and inner faces 124, 126 extending between opposite side edges 128, 130 defining a width that is preferably equal to or greater than the circumference of the exhaust pipe 12. The inner layer 116 has opposite outer and inner faces 136, 138 extending between opposite side edges 140, 142 that define a width that is less than the width of the outer layer 114, such that the inner layer 116 can be centered on the outer layer 114, and the side edges 128, 130 of the outer layer 114 can be folded or crimped around the side edges 140, 142 of the inner layer 116 to attach the respective layers 114, 116 together without use of an adhesive layer, as described above. Upon wrapping the heat shield 110 about the exhaust pipe, such as by hand, supplemental fastening mechanisms can be used to maintain the heat shield 110 in fixed relation about the exhaust pipe, such as through use of the hose clamp type straps or snaps, for example, discussed above.

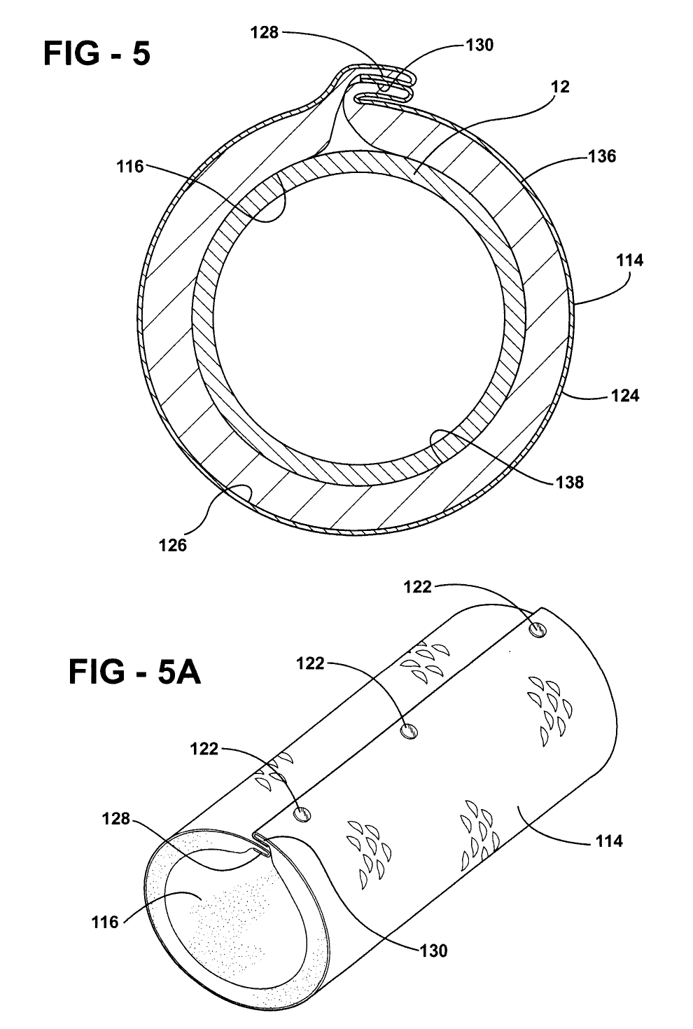

In addition, at least one of the opposite side edges 128, 130 of the outer layer 114 that is crimped over the inner layer 116 can be folded outwardly back upon itself so that the outer layer 114 does not make contact with the exhaust pipe 12, while the other of the side edges 128, 130 is wrapped in overlapping relation to the folded over side edge. Of course, as shown in FIG. 5, it should be recognized that since the outer layer 114 is preferably crimped so that the side edges 128, 130 are spaced radially outwardly from the inner face 138 of the inner layer 116, the opposite side edges 128, 130 of the outer layer 114 could be simply overlapped relative to one another without bringing the outer layer 114 into contact with the exhaust pipe 14. Further, as shown by way of example and without limitation, fasteners, such as snaps 122 can be incorporated to maintain the heat shield 110 in its fixed relation to the exhaust pipe.

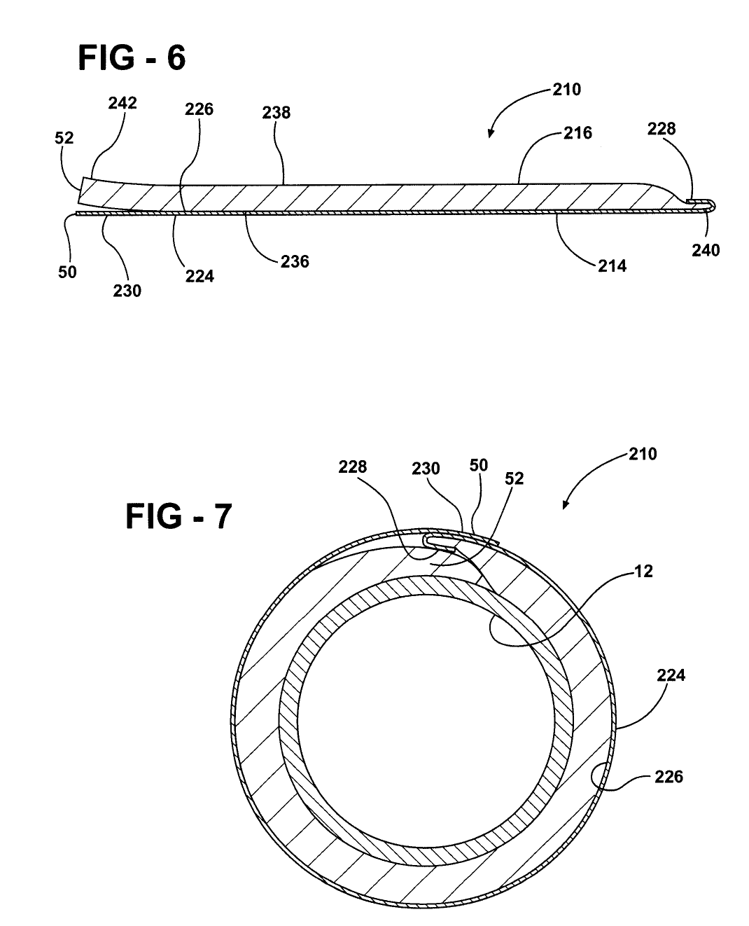

A heat shield 210 constructed according to yet another presently preferred embodiment is shown in FIG. 6. The heat shield 210 has an outer layer 214 and an inner layer 216 constructed from the same corresponding materials as discussed above, and is a one piece construction capable of being handled with risk of the outer layer 214 and the inner layer 216 falling apart, such that they can be wrapped by hand to encapsulate the exhaust pipe 12. The outer layer 214 has opposite outer and inner faces 224, 226 extending between opposite side edges 228, 230 defining a width that is preferably equal to or greater than the circumference of the exhaust pipe 12. The inner layer 216 has opposite outer and inner faces 236, 238 extending between opposite side edges 240, 242 that define a width that can be less than, equal to or greater than the width of the outer layer 214. Regardless, the inner layer 216 is appropriately sized to be assured of wrapping completely about the circumference of the exhaust pipe 12 to prevent heat from radiating outwardly therefrom. One side edge 228 of the outer layer 214 is crimped over the adjacent side edge 240 of the inner layer 216 to attach the outer and inner layers 214, 216 to one another without the need for an adhesive layer, as described above. The other side edges 230, 242 of the outer and inner layers 214, 216, respectively, remain detached and free from one another to provide free edges 50, 52, respectively. Accordingly, the outer and inner layers 214, 216 are only attached to one another via the crimped portion.

As shown in FIG. 7, in assembly of the heat shield 210 to the exhaust pipe 12, the free edge 52 of the inner layer 216 can be place against the exhaust pipe 12 and heat shield 210 can then be wrapped about the exhaust pipe, such as by hand. The crimped side edge 228 of the outer layer is wrapped in overlapping relation to the inner layer free edge 52 such that the inner layer 216 encapsulates and mates with the complete circumference of the exhaust pipe 12. The free edge 50 of the outer layer can either be placed outwardly from the crimped side edge 228 and in overlapping relation therewith such that the crimped edge 228 of the outer layer 214 is sandwiched between the inner layer 216 and the outer layer 214, as shown, or it could remain inwardly from the crimped side edge 228, if desired. As such, the inner layer side edges 240, 242 are overlapped with one another to bring the inner face 238 of the inner layer 216 adjacent one side edge 240 into mating contact with the outer face 236 of the inner layer 216 adjacent the other side edge 242 to form a complete circumferential layer of the inner layer 216 about the exhaust pipe. If the free edge 50 is placed outwardly from the crimped side edge 228, it could be adhered with a high temperature adhesive to the outer face 224 of the outer layer 214, if desired, or it could otherwise be maintained via circumferential hose clamp type straps or snaps, as discussed above, or by other fastening mechanisms, such as a weld joint, e.g. spot weld, for example. During wrapping of the heat shield 210 about the exhaust pipe 12, the outer and inner layers 214, 216 are able to move or shift circumferentially relative to one another since the edges 50, 52 remain free from attachment to one another and the outer face surface 236 of the inner layer 216 remains unattached from the inner face surface 226 of the outer layer 214. As such, the outer and inner layers 214, 216 can move circumferentially relative to one another without concern of buckling.

In construction of the heat shields 10, 110, 210, the outer layers 14, 114, 214 can expanded material, embossed or corrugated materials, cut to size, then and then attached to appropriately sized inner layers 16, 116, 216 via a crimping process. Otherwise, the material for the inner layers 16, 116, 216 can be placed on the material for the outer layers 14, 114, 214, and then the outer layer can be embossed or corrugated, and then the respective layers can be cut to their desired widths and lengths, depending on the particular embodiment of heat shield being constructed. Lastly, the attached outer and inner layers are formed, such as by hand wrapping, about the exhaust pipe and attached thereto. Of course, when utilizing the first embodiment 10 having opposite halves, the halves can be preformed via a pre-sized die on a press, if desired. It should be recognized that the ends of the heat shields can be left open, such that the inner layer is exposed, or the outer layer could be folded or crimped thereover. Additionally, an epoxy or the like could be applied at the ends of the inner layer to prevent it from becoming damaged, such as from water off a road surface.

Obviously, many modifications and variations of the present invention are possible in light of the above teachings. It is, therefore, to be understood that within the scope of the appended claims, the invention may be practiced otherwise than as specifically described.

What is claimed is:

1. A heat shield that is hand wrappable about a circumference of an exhaust pipe, comprising:
an outer layer of wrappable metal material having opposite inner and outer faces extending between opposite side edges, said opposite side edges providing a width of said outer layer;
an inner layer of non-woven insulation having opposite inner and outer faces extending between opposite side edges, said opposite side edges of said inner layer providing a width of said inner layer that is less than said width of said outer layer; and
wherein said inner layer outer face is facing said outer layer inner face and said outer layer side edges are arranged adjacent said inner layer side edges with at least one of said outer layer side edges being crimped over one of said inner layer side edges and compressing said inner layer to provide a crimped portion with said outer layer inner face remaining substantially unattached to said inner layer outer face, said inner layer width being sufficient to extend completely about the circumference of the exhaust pipe upon wrapping the heat shield about the circumference of the exhaust pipe.

2. The heat shield of claim 1 wherein said outer layer is expanded metal.

3. The heat shield of claim 1 wherein the other of said outer layer side edges is unattached and free from the adjacent inner layer side edge to provide a free portion.

4. The heat shield of claim 3 wherein said crimped portion is sandwiched between said other of said outer layer side edges and the adjacent inner layer side edge.

5. The heat shield of claim 4 wherein said inner layer side edges overlap one another.

6. The heat shield of claim 1 wherein said outer layer and said inner layer are formed as separate pairs of outer layer and inner layer portions.

7. The heat shield of claim 1 wherein said crimped portion is folded back upon itself to bring the outer layer into contact with itself.

8. The heat shield of claim 1 wherein both of said outer layer side edges are crimped about the adjacent inner layer side edges.

9. A method of constructing a wrappable heat shield for an exhaust pipe, comprising:
providing an outer layer of metal material having opposite inner and outer faces extending between opposite side edges providing a width of the outer layer;
providing an inner layer of non-woven insulation material having opposite inner and outer faces extending between opposite side edges providing a width of the inner layer;
placing said outer face of said inner layer in abutment with said inner face of said outer layer with said opposite side edges of said outer layer being arranged adjacent said opposite side edges of said inner layer; and
crimping at least one of said side edges of said outer layer over the adjacent side edge of said inner layer to fix said outer layer to said inner layer with said inner face of said outer layer remaining unattached with said outer face of said inner layer.

10. The method of claim 9 further including providing expanded metal for said outer layer.

11. The method of claim 9 further including leaving the other of said outer layer side edges unattached and free from the adjacent inner layer side edge.

12. The method of claim 11 further including providing said inner layer with a width sufficient to extend beyond the adjacent unattached outer layer side edge.

13. The method of claim 9 further including reverse folding the crimped side edge of the outer layer back on itself to bring the outer layer into contact with itself.

14. The method of claim 9 further including providing the inner layer with a width that is less than the width of the outer layer.

15. The method of claim 14 further including placing said inner layer side edges in generally centered relation to said outer layer side edges and crimping both outer layer side edges over the adjacent inner layer side edges.

16. A method of installing a heat shield on an exhaust pipe, comprising:
providing the heat shield with an outer layer of metal having opposite inner and outer faces extending between opposite side edges and an inner layer of insulation material having opposite inner and outer faces extending between opposite side edges arranged adjacent respective ones of said outer layer side edges with at least one of said outer layer side edges being crimped over the adjacent inner layer side edge to fix said outer layer to said inner layer with said inner face of said outer layer remaining substantially unattached to said outer face of said inner layer; and
wrapping said heat shield about said exhaust pipe and bringing said inner layer into complete circumferential contact with the exhaust pipe.

17. The method of claim 16 further including using expanded metal for said outer layer.

18. The method of claim 16 further including leaving the other of said outer layer side edges unattached and free from the adjacent inner layer side edge.

19. The method of claim 18 further including inserting the crimped edge of said outer layer between the other of said outer layer side edges and the adjacent inner layer side edge.

20. The method of claim 19 further including overlapping the inner layer side edges with one another and bringing the inner face of said inner layer adjacent one side edge into mating contact with the outer face of said inner layer adjacent the other side edge to form a complete circumferential layer of said inner layer about the exhaust pipe.

21. The method of claim 16 further including providing the heat shield with both of said outer layer side edges being crimped about the adjacent inner layer side edges.

22. The method of claim 16 further including providing the heat shield with said crimped edge being folded back upon itself to bring the outer layer into contact with itself.

23. The method of claim 16 further including providing the heat shield with said outer layer and said inner layer being formed as separate pairs outer layer and inner layer portions and bringing said separate portions together about the exhaust pipe during the wrapping step.

24. The method of claim 23 further including maintaining said separate portions in attached relation with the exhaust pipe with hose clamp type fasteners.

25. The method of claim 16 further including providing snaps adjacent said opposite side edges of said outer layer and bringing said snaps into snapping engagement during the wrapping step to maintain said heat shield in fixed relation with the exhaust pipe.
